(19) United States
(12) Patent Application Publication
(10) Pub. No.: US 2011/0030739 A1
(43) Pub. Date: Feb. 10, 2011

(54) CORE WASH RECIRCULATING TANK SYSTEM

(75) Inventor: Gregory D. Watkins, Clay City, IN (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company LLC, Warrenville, IL (US)

(21) Appl. No.: 12/536,533

(22) Filed: Aug. 6, 2009

(51) Int. Cl. B08B 3/04

(52) U.S. Cl. 134/104.2

(57) ABSTRACT

A core wash tank has a core wash bath compartment (14) for holding core wash (16) into which sand cores can be immersed for treatment and a single overflow compartment (30) separated from the core wash bath compartment by a divider wall (28) that defines an overflow level for core wash in the core wash bath compartment to overflow into the overflow compartment. A core wash recirculation system has a pump (42) for drawing core wash from the overflow compartment and pumping core wash into the core wash bath compartment.

### FIELD OF THE DISCLOSURE

This disclosure relates to foundry equipment, especially a core wash recirculating tank system having a core wash tank into which sand cores that are used for casting metal parts are dipped.

### BACKGROUND OF THE DISCLOSURE

A core wash that is applied to a sand core is intended to treat the core in a way that improves the core's surface finish and its resistance to erosion. A representative core wash comprises a refractory that is suspended in a liquid. Various core wash formulations are described in patents and other literature and may include additional constituents besides the refractory and liquid.

In the mass production of castings that use sand cores, the cores are prepared for use by steps that include dipping in core wash. A known dipping process comprises immersing a core in a core wash bath compartment of a recirculating core wash tank. Because the refractory is suspended in the liquid, recirculation of core wash promotes better uniformity of the suspension throughout the bath.

The liquid level of the bath is established by an excess of core wash in the wash system relative to the volume of the core wash bath compartment. The recirculation of core wash causes core wash in the core wash bath compartment to continuously overflow opposite side walls of that compartment and spill into overflow compartments at opposite sides of the core wash bath compartment. Recirculation occurs by pumping core wash out of each of the overflow compartments and reintroducing the core wash into the bath Immersion of cores in the core wash bath compartment also displaces liquid, adding to the overflow.

Depending on the sizes and shapes of cores that are being dipped in the core wash bath compartment, overflow into the respective compartments may not be uniform or consistent, and that can create imbalance in the system requiring operator intervention to rebalance the liquid levels in the overflow compartments in order to maintain proper consistency and suspension of the refractory. Because separate pumps are used to recirculate liquid from the respective overflow compartments, rebalance is performed by readjusting the respective pumps. That typically involves the attention of an operator.

Because core chipping may occasionally occur, core chips can settle on the bottom of the tank. Consequently, the tank is typically drained from time to time to allow chips to be removed. That also involves operator attention.

### SUMMARY OF THE DISCLOSURE

One general aspect of this disclosure relates to a core wash recirculating tank system comprising a core wash tank having a core wash bath compartment for holding core wash into which sand cores can be immersed for treatment and a single overflow compartment separated from the core wash bath compartment by a divider wall that defines an overflow level for core wash in the core wash bath compartment to overflow into the overflow compartment, and a core wash recirculation system comprising a pump for drawing core wash from the overflow compartment and pumping core wash into the core wash bath compartment.

Another general aspect relates to a core wash recirculating tank system comprising a core wash tank having a core wash bath compartment for holding core wash into which sand cores can be immersed for treatment and an overflow compartment separated from the core wash bath compartment by a divider wall that defines an overflow level for core wash in the core wash bath compartment to overflow into the overflow compartment, and a core wash recirculation system comprising a pump for drawing core wash from the overflow compartment and pumping core wash into the core wash bath compartment, the divider wall extending between opposite upright tank walls and having a height that is less than height of the opposite upright tank walls, and further comprising a removable basket in the core wash bath compartment for collecting core chips that fall down in the core wash bath compartment.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a top plan view of a recirculating core wash tank.

FIG. 2 is front elevation view, partly in cross section, of the tank of FIG. 1.

### DETAILED DESCRIPTION

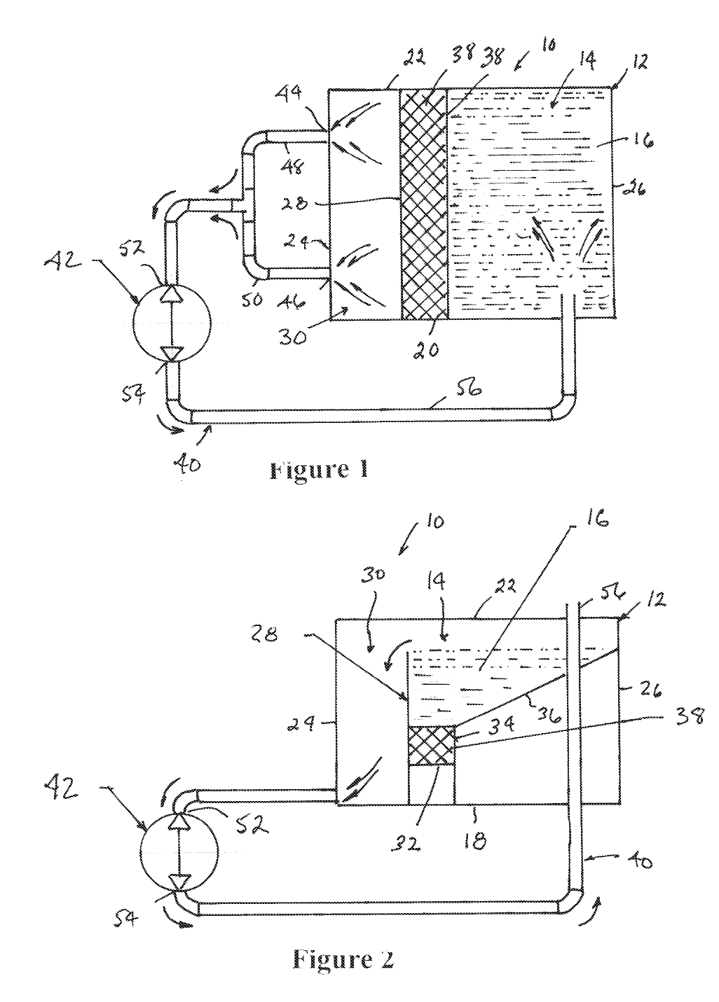

FIGS. 1 and 2 show a core wash tank system 10 that comprises a core wash tank 12 having core wash bath compartment 14 containing core wash 16 into which sand cores (not shown) can be immersed for treatment. Tank 12 has a floor 18, a front vertical tank wall 20, a rear vertical tank wall 22, and two vertical tank side walls 24 and 26. All four tank walls extend upright from respective margins of the floor's perimeter and adjacent tank walls are joined together. A divider wall 28 whose height is less than those of tank walls 20, 22, 24, and 26 extends from tank wall 20 to tank wall 22 to separate core wash bath compartment 14 from an overflow compartment 30.

A portion of floor 18 forms a bottom wall of overflow compartment 30. Core wash bath compartment 14 has its own bottom wall 32 that is spaced above floor 18 and extends between walls 20 and 22, joining along its left-hand margin as viewed in the Figures with divider wall 28. Opposite divider wall 28, core wash bath compartment 14 is bounded by a side wall that extends between walls 20 and 22 and that comprises a vertical wall portion 34 and an inclined wall portion 36. Wall portion 34 joins with bottom wall 32 and wall portion 36 joins with wall 26.

Bottom wall 32, vertical wall portion 34, and a portion of divider wall 28 that is directly opposite wall portion 34 form a rectangular space where core chips can collect. A catch pan, or basket, 38 of similar rectangular shape is disposed to fit in that space so that chips can collect in it rather than on bottom wall 32. Inclined wall portion 36 is downwardly inclined in a direction from tank wall 26 toward bottom wall 32 to direct chips that fall onto it toward and into the open top of basket 38.

Basket 38 is removable to allow it to be elevated out of core wash bath compartment 14 so that collected chips can be more conveniently removed. Basket 38 may have some perforations to allow liquid to drain from the basket interior without allowing larger chips to pass through. Basket 38 may be hoisted by a suitable device or mechanism (not shown). Inclined wall portion 36 aids in directing chips into basket 38.

Core wash tank system 10 also has a wash recirculation system 40 that comprises a pump 42. Overflow compartment 30 comprises two drains 44, 46 that are connected by pipes 48, 50 to a suction inlet 52 of pump 42. Pump 42 also has an outlet 54. A pipe 56 runs from outlet 54 to the top of core wash bath compartment 14.

When pump 42 operates, it draws core wash from the bottom of overflow compartment 30 and pumps the wash back into core wash bath compartment 14.

The liquid level of the core wash bath is established by an excess of core wash 16 in wash recirculation system 40 relative to the volume of core wash bath compartment 14. The recirculation of core wash by pump 42 causes core wash in core wash bath compartment 14 to continuously overflow divider wall 28 and spill into overflow compartment 30 along only one side of compartment 14. When a core is immersed in core wash bath compartment 14 additional core wash overflows into compartment 30.

Because there is only a single overflow compartment, the entire overflow from core wash bath compartment 14 overflows into compartment 30 and the potential for imbalance that exists with two overflow tanks on opposite sides is avoided. This eliminates rebalancing liquid level and inherently maintains better consistency and suspension of the refractory.

What is claimed is:

1. A core wash recirculating tank system comprising:
a core wash tank having a core wash bath compartment for holding core wash into which sand cores can be immersed for treatment and a single overflow compartment separated from the core wash bath compartment by a divider wall that defines an overflow level for core wash in the core wash bath compartment to overflow into the overflow compartment,
and a core wash recirculation system comprising a pump for drawing core wash from the overflow compartment and pumping core wash into the core wash bath compartment.

2. A core wash recirculating tank system as set forth in claim 1 in which the core wash tank comprises upright tank walls and the divider wall extends between opposite tank walls and has a height that is less than heights of the upright tank walls.

3. A core wash recirculating tank system as set forth in claim 2 in which the core wash bath compartment comprises a generally horizontal bottom wall joining with the divider wall and a side wall that is opposite the divider wall and extends from the bottom wall to one of the upright tank walls.

4. A core wash recirculating tank system as set forth in claim 3 in which the side wall of the core wash bath compartment comprises an inclined wall portion that is downwardly inclined in a direction from the one upright tank wall toward the bottom wall of the core wash bath compartment.

5. A core wash recirculating tank system as set forth in claim 4 in which the side wall of the core wash bath compartment further comprises a generally vertical wall portion joining the inclined wall portion with the bottom wall.

6. A core wash recirculating tank system as set forth in claim 5 further comprising a removable basket disposed in the core wash bath compartment between the divider wall and the generally vertical wall portion of the core wash bath compartment side wall at a level below the inclined wall portion for collecting core chips that fall down in the core wash bath compartment.

7. A core wash recirculating tank system comprising:
a core wash tank having a core wash bath compartment for holding core wash into which sand cores can be immersed for treatment and an overflow compartment separated from the core wash bath compartment by a divider wall that defines an overflow level for core wash in the core wash bath compartment to overflow into the overflow compartment, and
a core wash recirculation system comprising a pump for drawing core wash from the overflow compartment and pumping core wash into the core wash bath compartment,
the divider wall extending between opposite upright tank walls and having a height that is less than height of the opposite upright tank walls,
and further comprising a removable basket in the core wash bath compartment for collecting core chips that fall down in the core wash bath compartment.

8. A core wash recirculating tank system as set forth in claim 7 in which the core wash bath compartment comprises a generally horizontal bottom wall joining with the divider wall and a side wall that is opposite the divider wall and extends from the bottom wall to one of the opposite upright tank walls, the side wall of the core wash bath compartment comprising an inclined wall portion that is downwardly inclined in a direction from the one upright tank wall toward the bottom wall of the core wash bath compartment to aid in directing falling core chips into the basket.
